(19) United States
(12) Patent Application Publication
(10) Pub. No.: US 2024/0026062 A1
(43) Pub. Date: Jan. 25, 2024

(54) WATER-BASED POLYURETHANE DISPERSIONS AND THEIR PREPARATION

(71) Applicant: Dow Global Technologies LLC, Midland, MI (US)

(72) Inventors: Kristeen Esther Joseph, Pearland, TX (US); Sung-Yu Ku, Manvel, TX (US); Heather M. Wiles, Saginaw, MI (US)

(21) Appl. No.: 18/044,673

(22) PCT Filed: Aug. 17, 2021
(86) PCT No.: PCT/US2021/046284

§ 371 Date: Mar. 9, 2023

Related U.S. Application Data
(60) Provisional application No. 63/081,621, filed on Sep. 22, 2020.

(51) Int. Cl. C08G 18/65; C08G 18/12; C08L 75/04; C08G 18/24; C08G 18/08

(52) U.S. Cl. CPC C08G 18/6541; C08G 18/12; C08L 75/04; C08G 18/244; C08G 18/0852; C08G 18/0866; C08L 2201/54

(57) ABSTRACT

A prepolymer comprising acid functionality is made by a process comprising the step of contacting: (i) a di-isocyanate, (ii) a diol containing an acid group, and (iii) a polyol without an acid group, the contacting conducted under reaction conditions and in a solvent consisting essentially of dipropylene glycol dimethyl ether. The prepolymer is useful in the preparation of water-based polyurethane dispersions.

### FIELD

The present invention, in various embodiments, relates generally to processes for making prepolymers comprising an acid group, processes for making water-based polyurethane dispersions, and to water-based polyurethane dispersions (PUD).

### BACKGROUND OF THE INVENTION

Water-based polyurethane dispersions (PUD) are well known, environment friendly resins for different coatings, inks, and adhesives applications. There are two different approaches in commercial production of polyurethane dispersions, the acetone process and the prepolymer process. As acetone is a flammable solvent, the prepolymer process is the more widely used one. In this process, PUDs are made from a di-isocyanate and a polyol. In this two-step process, a prepolymer is firstly made by reacting the di-isocyanate and the polyol in the presence of a tin catalyst. A polyol containing an acid group, e.g., 2,2-dimethylolpropionic acid (DMPA), is used to react with the di-isocyanate and incorporate acid functionality into the polyurethane (PU) prepolymer. In the second step, the acid is neutralized with an amine, and the neutralized PU polymer is dispersed in water and chain-extended by polyol or diamine to obtain the PUD. In step one, a solvent like N-methyl-2-pyrrolidone (NMP) has been used for many years to dissolve DMPA during the prepolymer synthesis due to its good affinity for DMPA.

NMP is a particularly important, versatile solvent and the preferred reaction medium for the PUD chemical industry because of its low volatility, thermal stability, high polarity, aprotic, noncorrosive and good solubility properties. However, it has been demonstrated that NMP shows reproductive toxicity in animal testing. As a result, NMP has recently been classified as a potential reprotoxic substance under the Registration, Evaluation, Authorization and Restriction of Chemical Substances (REACH), which drives the increasing safety and regulatory concerns at global level.

Therefore, a solvent with a better environmental, health and safety (EHS) profile and similar solubility properties is desired to replace NMP. In particular, it would be desirable to develop a package solution of a new emulsifier coupled with a non-hazardous, non-flammable solvent that can work well in a PUD formulation for coatings application.

### SUMMARY

In one embodiment the invention is a process for making a prepolymer comprising acid group, the process comprising the step of contacting
(i) a di-isocyanate,
(ii) a diol containing an acid group, and
(iii) a polyol without an acid group,
   the contacting conducted under reaction conditions and in a solvent consisting essentially of dipropylene glycol dimethyl ether. In one embodiment, the acid group of the diol containing an acid group is a carboxylic acid group. In one embodiment, the diol containing an acid group is 2,2-dimethylolbutanoic acid (“DMBA”). In one embodiment, the contacting step to form the prepolymer with acid group further comprises a metal salt catalyst. In one embodiment, the metal salt catalyst is an organic tin salt.

In one embodiment the invention is a three-step process for making a water-based polyurethane dispersion (PUD), the process comprising the steps of:
(1) forming a prepolymer with an acid group by contacting:
   (i) a di-isocyanate,
   (ii) a diol containing an acid group, and
   (iii) a polyol without an acid group,
the contacting conducted under reaction conditions and in a solvent consisting essentially of dipropylene glycol dimethyl ether;
(2) neutralizing the acid group of the prepolymer with a base; and
(3) dispersing the neutralized prepolymer in water.

In one embodiment, the acid group of the diol containing an acid group is a carboxylic acid group. In one embodiment, the diol containing an acid group is 2,2-dimethylolbutanoic acid (“DMBA”). In one embodiment, the contacting step to form the prepolymer with acid group further comprises a metal salt catalyst. In one embodiment, the metal salt catalyst is an organic tin salt. In one embodiment, the process further comprises (4) adding a chain extender to the neutralized prepolymer in water, wherein the chain extender is a polyol or a diamine.

In some embodiments where the diol containing an acid group is 2,2-dimethylolbutanoic acid, the use of dipropylene glycol dimethyl ether as the solvent can advantageously provide improved solubility (particularly relative to 2,2-dimethylolpropionic acid) which can result in more stable films formed by the PUD without precipitated solids. In addition, in some embodiments, the combination of 2,2-dimethylolbutanoic acid with dipropylene glycol dimethyl ether can provide films formed by the PUD with desirable hardness.

In one embodiment the invention is a polyurethane dispersion comprising (i) a chain-extended prepolymer comprising a neutralized acid group, (ii) dipropylene glycol dimethyl ether, and (iii) water. In one embodiment, the prepolymer comprises 5 to 60 percent by mass of the polyurethane dispersion.

### BRIEF DESCRIPTION OF THE DRAWING

FIG. 1 illustrates a simple reaction mechanism for a water-based PUD. A PU polymer is made by reacting a di-isocyanate and a polyol in the presence of a tin catalyst. 2,2-Dimethylolbutanoic acid is a diol, and it is used to incorporate carboxylic acid functionality into the PU prepolymer. In the second step, the carboxylic acid functionality is neutralized with an amine, and the neutralized PU polymer is dispersed in water and chain-extended by polyol or diamine to obtain the PUD. In step one, a solvent is used to dissolve DMBA during the prepolymer synthesis. In commercial practice, NMP is the most widely used solvent for this purpose. In this invention, the solvent is dipropylene glycol dimethyl ether (“DPGDME”) which is an aprotic glycol ether.

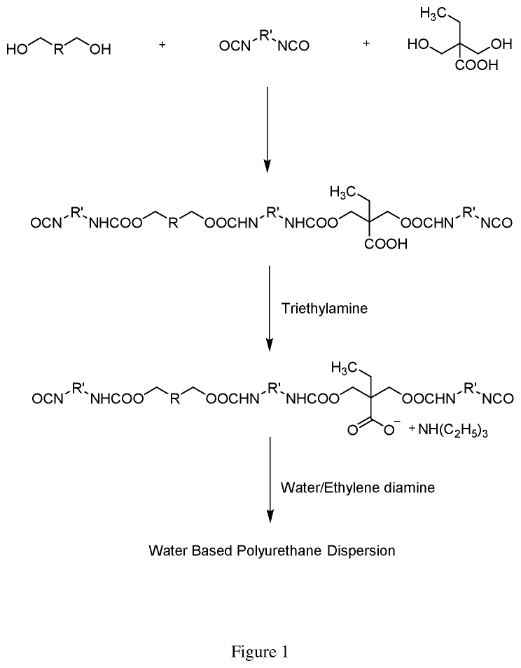

### DETAILED DESCRIPTION

### Definitions

For purposes of United States patent practice, the contents of any referenced patent, patent application or publication are incorporated by reference in their entirety (or its equivalent U.S. version is so incorporated by reference), especially with respect to the disclosure of definitions (to the extent not inconsistent with any definitions specifically provided in this disclosure) and general knowledge in the art.

Unless stated to the contrary, implicit from the context, or customary in the art, all parts and percents are based on weight and all test methods are current as of the filing date of this disclosure.

The numerical ranges disclosed herein include all values from, and including, the lower and upper value. For ranged containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

“Prepolymer” and like terms mean a compound made from the reaction of a di-isocyanate and a polyol. Prepolymers are formed by combining an excess of diisocyanate with polyol. As shown in the illustration below, one of the isocyanate groups (NCO) of the di-isocyanate reacts with one of the hydroxy groups (OH) of the polyol; the other end of the polyol reacts with another di-isocyanate. The resulting prepolymer has an isocyanate group on both ends. The prepolymer is a di-isocyanate itself, and it reacts like a di-isocyanate but with several important differences. When compared with the original di-isocyanate, the prepolymer has a greater molecular weight, a higher viscosity, a lower isocyanate content by weight (% NCO), and a lower vapor pressure.

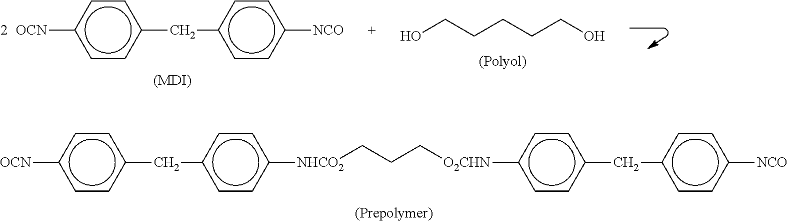

The prepolymer used in the practice of this invention includes one or more units derived from a diol containing an acid group (e.g., DMBA or dimethylol pentanoic acid) to introduce carboxylic acid functionality into the prepolymer.

“Acid group”, “acid functionality” and like terms mean a substituent on a monomer, oligomer or polymer that donates protons, or hydrogen ions, in an aqueous solution.

“Reaction conditions” and like terms generally refer to temperature, pressure, reactant concentrations, catalyst concentration, cocatalyst concentration, monomer conversion, product and by-product (or solids) content of the reaction mixture (or mass) and/or other conditions that influence the properties of the resulting product. The reaction conditions for forming a prepolymer from a di-isocyanate and a polyol are well known in the art, and they typically include a temperature of 40° C. to 150° C., atmospheric pressure, a nitrogen atmosphere and the absence of water.

“Solvent” and like terms mean a substance that is capable of dissolving another substance (i.e., a solute) to form an essentially uniformly dispersed mixture (i.e., solution) at the molecular or ionic size level.

“Aprotic” and like terms describe a solvent, e.g., a glycol ether, that is not capable of donating a proton. Protic solvents are solvents that have a hydrogen atom bound to an oxygen (as in a hydroxyl group) or a nitrogen (as in an amine group). In general terms, any solvent that contains labile H+ is a protic solvent. Representative protic solvents include DOWANOL™ DPM (dipropylene glycol methyl ether), DOWANOL™ TPM (tripropylene glycol methyl ether), DOWANOL™ DPnP (dipropylene glycol n-propyl ether), DOWANOL™ DPnB (dipropylene glycol n-butyl ether), and DOWANOL™ TPnB (tripropylene glycol n-propyl ether). The molecules of such solvents readily donate protons (H+) to reagents. The glycol ethers used in the practice of this invention, e.g., PROGLYDE™ DMM (dipropylene glycol dimethyl ether or DPGDME), do not contain labile H+. The commercially available aprotic solvents that can be used in the practice of this invention may contain minor amounts of residual protic compounds from the manufacturing process by which the aprotic solvent is made. “Minor amounts” means typically less than or equal to (≤) 1 wt %, or ≤0.5 wt %, or ≤0.1 wt %, or ≤0.05 wt %, or ≤0.01 wt %, of protic compound in the aprotic solvent based on the combined weight of the aprotic solvent and protic compound.

“Neat” and like terms mean single or undiluted. A solvent containing neat dipropylene glycol dimethyl ether means that dipropylene glycol dimethyl ether is the only component of the solvent.

### Di-isocyanate

The di-isocyanate may be an aromatic, an aliphatic, or a cycloaliphatic di-isocyanate, or a combination of two or more of these compounds. A nonlimiting example of a structural unit derived from a di-isocyanate (OCN—R—NCO) is represented by formula (I) below:

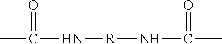

in which R is an alkylene, cyclo-alkylene, or arylene group. Representative examples of these di-isocyanates can be found in U.S. Pat. Nos. 4,012,445; 4,385,133; 4,522,975 and 5,167,899.

Nonlimiting examples of suitable di-isocyanates include 4,4′-di-isocyanato-diphenyl methane, p-phenylene di-isocyanate, 1,3-bis(isocyanatomethyl)-cyclohexane, 1,4-di-isocyanato-cyclohexane, hexamethylene di-isocyanate, 1,5-naphthalene di-isocyanate-3,3′-dimethyl-4,4′-biphenyl di-isocyanate, 4,4′-di-isocyanatodicyclohexyl-methane, 2,4-toluene di-isocyanate, and 4,4′-di-isocyanato-diphenylmethane.

### Polyol

The polyols used in the practice of this invention, including both those with and without an acid group, have a molecular weight (number average) in the range from 200 to 10,000 g/mole. Nonlimiting examples of suitable polyols without an acid group include polyether diols (yielding a “polyether PU”); polyester diols (yielding a “polyester PU”); hydroxy-terminated polycarbonates (yielding a “polycarbonate PU”); hydroxy-terminated polybutadienes; hydroxy-terminated polybutadiene-acrylonitrile copolymers; hydroxy-terminated copolymers of dialkyl siloxane and alkylene oxides, such as ethylene oxide, propylene oxide; natural oil diols, and any combination thereof. In one embodiment a single polyol is used. In one embodiment, a combination of two or more polyols are used. In one embodiment one or more of the foregoing polyols may be mixed with an amine-terminated polyether and/or an amino-terminated polybutadiene-acrylonitrile copolymer, depending upon the rate of reaction and the desired polymer structure. Triols and other polyols with more than two hydroxy groups can also be used, e.g., glycerol, trimethylolpropane, and the like. Further examples of polyols useful in the practice of this invention are found in U.S. Pat. No. 4,012,445.

In the present invention, the total hydroxyl group equivalent number of the polyol compound is preferably 120 to 3,000. When the number of hydroxyl equivalent is within this range, the aqueous resin dispersion containing the obtained polyurethane resin can be easily produced, and a coating film excellent in terms of hardness can be easily obtained. From the viewpoints of the storage stability of the obtained aqueous polyurethane resin dispersion and the hardness, drying property and thickening property of the coating film obtained by coating, the hydroxyl group equivalent number is preferably 150 to 3000 or 150 to 800, or 200 to 700, or 300 to 600.

The number of hydroxyl equivalent can be calculated by the following formulas (1) and (2). Number of hydroxyl equivalent of each polyol is equal to the molecular weight of each polyol divided by the number of hydroxyl groups of each polyol (excluding phenolic hydroxyl group) (1) total hydroxyl group equivalent number of polyol is equal to the total number of moles of M divided by polyol (2). In the case of the polyurethane resin, M in the formula (2) is [[hydroxyl equivalent number of the polyol compound times mol number of the polyol compound] plus [Hydroxyl equivalent number times number of moles of acid group-containing polyol]].

To introduce acid functionality into the prepolymer, at least some portion of the polyol that reacts with the di-isocyanate is a diol that contains an acid group, e.g., a carboxyl group. The acid group-containing diol contains two hydroxyl groups and one or more acidic groups in one molecule. As the diol containing an acid group, those having two hydroxyl groups and one carboxyl group in one molecule are preferable. Specifically, embodiments of the present invention utilize 2,2-dimethylolbutanoic acid or 2,2-dimethylolpentanoic acid. In some embodiments, the diol containing an acid group is 2,2-dimethylolbutanoic acid.

### Chain Extenders

Chain extenders are not necessary to the practice of this invention, but can be used if desired. Chain extenders can be particularly useful make them more stable as a polyurethane dispersion. When used, the chain extender can be added to the neutralized prepolymer in water. If used, then these are polyfunctional, typically difunctional, and can be aliphatic straight or branched chain polyols or amines having from 2 to 10 carbon atoms, inclusive, in the chain. Illustrative of such polyols are the diols ethylene glycol, 1,3-propanediol, 1,4-butanediol, 1,5-pentanediol, 1,6-hexanediol, neopentyl glycol, and the like; 1,4-cyclohexanedimethanol; hydroquinonebis-(hydroxyethyl)ether; cyclohexylenediols (1,4-, 1,3-, and 1,2-isomers), isopropylidenebis(cyclohexanols); diethylene glycol, dipropylene glycol, ethanolamine, N-methyldiethanolamine, and the like; and mixtures of any of the above. An example of such an amine is ethylene diamine.

The prepolymer can contain, for example, from 1 to 25 weight percent (wt %) of the chain extender component.

### Catalyst

The reaction of the di-isocyanate and polyol is promoted through the use of a catalyst. In some embodiments, the catalyst is a metal salt catalyst. Examples of catalyst include, but are not limited to, a salt of a metal with an organic or inorganic acid, such as a tin-based catalyst (e.g., trimethyltin laurylate, dibutyltin dilaurate and the like), or a lead-based catalyst (e.g., lead octylate, etc.) and organic metal derivatives, amine-type catalysts (e.g., triethylamine, N-ethylmorpholine, triethylenediamine, etc.), and diazobicycloundecene-type catalysts. Tin-based catalysts are preferred.

### Solvent

The solvent used in the present invention is dipropylene glycol dimethyl ether or DPGDME. The solvent used in this invention consists essentially of, or consists of, DPGDME. DPGDME has a high affinity in terms of solubility for the diol containing an acid group (e.g., DMBA). As described herein, DPGDME is useful for the preparation of PU prepolymers and PUDs. One example of a commercially available DPGDME that can be used in embodiments of the present invention is PROGLYDE™ DMM from The Dow Chemical Company.

Protic solvents such as ethylene glycol monobutyl ether, ethylene glycol monopropyl ether, diethylene glycol monoethyl ether, propylene glycol methyl ether, dipropylene glycol monomethyl ether and tripropylene glycol monomethyl ether, may be present in the DPGDME used in the present invention but only as a residue of the manufacturing process from which the aprotic component of in the solvent system is made, and then in only minor amounts, e.g., less than or equal to (≤) 1 wt %, based on the combined weight of the aprotic and protic compounds in the solvent system. The protic solvents are disfavored because they, like water, react fast with the isocyanate.

Optional materials that are not essential to the operability of, but can be included in, the solvent systems of this invention include, but are not limited to, antioxidants, colorants, water scavengers, stabilizers, fillers, diluents (e.g., aromatic hydrocarbons), and the like. These materials do not have any material impact on the efficacy of the solvent system for providing a reaction medium for the preparation of a prepolymer. These optional materials are used in known amounts, e.g., 0.10 to 5, or 4, or 3, or 2, or 1, weight percent based on the weight of the solvent system, and they are used in known ways.

### Use of the Solvent

The solvent used in this invention (DPGDME) is an eco-solvent, i.e., it does not have, or have at a reduced level, the toxicology issues associated with NMP. DPGDME is used in the same manner as mediums for the preparation of a prepolymer as NMP and other polar solvents.

### Polyurethane Dispersion

The process for producing an aqueous polyurethane dispersion (PUD) is a three-step process comprising: (1) preparing the prepolymer as described above, (2) neutralizing the acid functionality of the prepolymer, and (3) dispersing the prepolymer in water. In some embodiments, a fourth step can be included, which is adding a chain extender (e.g., the polyol or amine chain extenders discussed above) to the neutralized prepolymer. Virtually any base can be used as the neutralizing agent. Examples include, without limitation, trimethylamine, triethylamine, tri-isopropylamine, tributylamine, triethanolamine, N-methyldiethanolamine, N-ethyldiethanolamine, N-phenyldiethanolamine, dimethylethanolamine, diethylethanolamine, N-methylmorpholine, organic amines such as pyridine, inorganic alkali salts such as sodium hydroxide and potassium hydroxide, and ammonia. For the neutralization of carboxyl groups, organic amines are preferred, and tertiary amines more preferred, especially triethylamine.

The step of dispersing the polyurethane prepolymer in an aqueous medium can be performed using conventional equipment and techniques. For example, the prepolymer can be added to a blender of stirred water and mixed until a substantially homogeneous blend is obtained. Alternatively, water can be added to a blender of stirred prepolymer. The mixing is typically conducted at ambient conditions (23° C. and atmospheric pressure). Various additives, e.g., stabilizers, antioxidants, surfactants, etc., can be added to the dispersion in known amounts and using known methods. The amount of prepolymer in the dispersion can vary widely, but typically the prepolymer comprises 5 to 60, or 15 to 50, percent of the dispersion by mass.

In some embodiments, when formed into films, the polyurethane dispersions, according to some embodiments of the present invention made using DMBA and with DPGDME as the solvent, can be formed into films having improved hardness. The hardness can be evaluated using Martens hardness.

The following examples are nonlimiting illustrations of the invention.

### EXAMPLES

### Example 1—Solubility Evaluation

The solubility of certain diols containing an acid group (2,2-dimethylolpropionic acid (DMPA) and 2,2-dimethylolbutanoic acid (DMBA)) in dipropylene glycol dimethyl ether (DPGDME) and in N-methyl-2-pyrrolidone (NMP) are evaluated at different temperatures. The DPGDME used is PROGLYDE™ DMM (The Dow Chemical Company). The following concentrations with corresponding amounts of DMPA or DMBA and of solvent (DPGDME or NMP) are evaluated:

TABLE 1

| Concentration | Amount of DMPA or | Amount of Solvent (NMP or |
|---|---|---|
| (weight %) | DMBA (grams) | DPGDME) (grams) |
| 5 | 0.75 | 14.25 |
| 10 | 1.5 | 13.50 |
| 15 | 2.25 | 12.75 |
| 20 | 3.00 | 12.00 |
| 25 | 3.75 | 11.25 |

Using a 30 milliliter glass vial with a 24-mm black phenolic screw cap with poly seal liner from Fisher, the emulsifier (DMBA or DMPA) is added at 5 wt. %, 10 wt. %, 15 wt. %, 20 wt. %, and 25 wt. % in the solvent (NMP or DPGDME) as specified in Table 1. Samples are heated on a high throughput heating/mixing station from 25° C. to 100° C. in 10° C. increments while mixing at 500 rpm with a magnetic stir bar. Samples are then removed an image is taken to record solubility.

Certain key results are summarized in Table 2. An entry of “Yes” indicates completely soluble, and an entry of “No” means not fully soluble.

TABLE 2

| | DMPA in | DMPA in | DMBA in | DMBA in |
|---|---|---|---|---|
| Concentration | NMP | DPDGME | NMP | DPGDGME |
| (weight %) | (25° C.) | (95° C.) | (25° C.) | (75° C.) |
| 5 | Yes | No | Yes | Yes |
| 10 | Yes | No | Yes | Yes |
| 15 | Yes | No | Yes | Yes |
| 20 | Yes | No | Yes | Yes |
| 25 | Yes | No | Yes | Yes |

The solubility of DMPA was found to be poor in DPGDME. DMPA was completely soluble at room temperature (25° C.) at all concentrations up to 25 weight % upon mixing in NMP. In contrast, DMPA was not fully soluble in DPGDGME even at 5 weight % at a high temperature of 95° C. DMBA was found to be soluble at all concentrations up to 25 weight % at varying temperatures in both solvents tested (NMP and DPGDME). Thus, while DPGDME exhibited low solubilizing power for DMPA, it was found to fully dissolve DMBA at 75° C.

### Example 2—Polyurethane Dispersions

Polyurethane dispersions were made using DMPA or DMBA as the emulsifier in either NMP or DPGDME as the solvent. Table 3 shows the formulation when DMPA is the emulsifier and DPGDME or NMP is the solvent (Comparative Examples A and B), and Table 4 shows the formulation when DMBA is the emulsifier and DPGDME is the solvent Inventive Example 1):

TABLE 3

| Chemical | | Weight (g) |
|---|---|---|
| Poly(tetrahydrofuran) | Polyol without acid | 2.089 |
| (Mₙ of ~1000) (Sigma Aldrich) | group | |
| Poly(tetrahydrofuran) | Polyol without acid | 2.925 |
| (Mₙ of ~2000) (Sigma Aldrich) | group | |
| 4,4′-Methylene dicyclohexyl | Di-isocyanate | 3.315 |
| diisocyanate | | |
| DMPA | Diol with acid group | 0.585 |
| NMP or DPGDME | Solvent for Prepolymer | 1.755 |
| Triethylamine | Base (Neutralizer) | 0.415 |
| Water | | 13.845 |
| Ethylene Diamine (30% solution) | Chain Extender | 0.780 |

TABLE 4

| Chemical | | Weight (g) |
|---|---|---|
| Poly(tetrahydrofuran) | Polyol without acid | 2.089 |
| (Mₙ of ~1000) (Sigma Aldrich) | group | |
| Poly(tetrahydrofuran) | Polyol without acid | 2.925 |
| (Mₙ of ~2000) (Sigma Aldrich) | group | |
| 4,4′-Methylene dicyclohexyl | Di-isocyanate | 3.315 |
| diisocyanate | | |
| DMBA | Diol with acid group | 0.646 |
| DPGDME | Solvent for Prepolymer | 1.938 |
| Triethylamine | Base (Neutralizer) | 0.415 |
| Water | | 13.845 |
| Ethylene Diamine (30% solution) | Chain Extender | 0.780 |

### Preparation of Comparative Example A—Polyurethane Dispersion using DMPA in DPGDME

Prepolymers for a polyurethane dispersion (PUD) are formulated using the formulation provided in Table 3 as follows. The poly(tetrahydrofuran) (Mₙ of ˜1000) and poly(tetrahydrofuran) (Mₙ of ˜2000) polyols are heated in a Despatch Oven at 50° C. for 1 hour or until they become a liquid, and then are transferred into the glove box. The poly(tetrahydrofuran) polyols are then added to a 40 milliliter glass vial, and then DMPA and DPGDME are added. The formulation is mixed in a vortex mixer for about 30 seconds. Then, 4,4′-Methylene dicyclohexyl diisocyanate (Hi₂MDI) is added and the solution is mixed using a Flacktek speed mixer at 3,000 rpm for 1 minute. One drop (0.11 microliters) of catalyst (Dibutyltin Dilaurate—DBTDL) is added last, and the formulation is again mixed at 3,000 rpm for 1 minute using the Flacktek speed mixer. The prepolymers are then removed from the glove box and placed in an HTR heated/mixing station at 80° C. for 4 hours. After 4 hours, the samples are placed back into the glove box, and the triethylamine (neutralizer) is added. The samples are again mixed using the Flacktek speed mixer at 3,000 rpm for 1 minute. Then, the samples are removed from the glove box and deionized water is added in a fume hood. The samples are hand shaken vigorously for about 2 minutes and then placed in the Flacktek mixer at 3,000 rpm for 1 minute (on the benchtop)—repeated mixing 3 times or until samples are uniform. Then, in a fume hood, the ethylene diamine (chain extender) (30 wt % ethylene diamine in deionized water) is added. Samples are mixed again using the Flacktek speed mixer at 3,000 rpm for 1 minute or until samples are uniform. Samples are left overnight on the benchtop and coatings are made the following day.

### Preparation of Comparative Example B—Polyurethane Dispersion Using DMPA in NMP

Prepolymers for a polyurethane dispersion (PUD) are formulated using the formulation provided in Table 3 as follows. The poly(tetrahydrofuran) (Mₙ of ˜1000) and poly(tetrahydrofuran) (Mₙ of ˜2000) polyols are heated in a Despatch Oven at 50° C. for 1 hour or until they become a liquid, and then are transferred into the glove box. The poly(tetrahydrofuran) polyols are then added to a 40 milliliter glass vial, and then DMPA and NMP are added. The formulation is mixed in a vortex mixer for about 30 seconds. Then, 4,4′-Methylene dicyclohexyl diisocyanate (Hi₂MDI) is added and the solution is mixed using a Flacktek speed mixer at 3,000 rpm for 1 minute. One drop (0.11 microliters) of catalyst (Dibutyltin Dilaurate—DBTDL) is added last, and the formulation is again mixed at 3,000 rpm for 1 minute using the Flacktek speed mixer. The prepolymers are then removed from the glove box and placed in an HTR heated/mixing station at 80° C. for 4 hours. After 4 hours, the samples are placed back into the glove box, and the triethylamine (neutralizer) is added. The samples are again mixed using the Flacktek speed mixer at 3,000 rpm for 1 minute. Then, the samples are removed from the glove box and deionized water is added in a fume hood. The samples are hand shaken vigorously for about 2 minutes and then placed in the Flacktek mixer at 3,000 rpm for 1 minute (on the benchtop)—repeated mixing 3 times or until samples are uniform. Then, in a fume hood, the ethylene diamine (chain extender) (30 wt % ethylene diamine in deionized water) is added. Samples are mixed again using the Flacktek speed mixer at 3,000 rpm for 1 minute or until samples are uniform. Samples are left overnight on the benchtop and coatings are made the following day.

### Preparation of Inventive Example 1—Polyurethane Dispersion Using DMBA in DPGDME

Prepolymers for a polyurethane dispersion (PUD) are formulated using the formulation provided in Table 4 as follows. The poly(tetrahydrofuran) (Mₙ of ˜1000) and poly(tetrahydrofuran) (Mₙ of ˜2000) polyols are heated in a Despatch Oven at 50° C. for 1 hour or until they become a liquid, and then are transferred into the glove box. The poly(tetrahydrofuran) polyols are then added to a 40 milliliter glass vial, and then DMBA and DPGDME are added. The formulation is mixed in a vortex mixer for about 30 seconds. Then, 4,4′-Methylene dicyclohexyl diisocyanate (Hi₂MDI) is added and the solution is mixed using a Flacktek speed mixer at 3,000 rpm for 1 minute. One drop (0.11 microliters) of catalyst (Dibutyltin Dilaurate—DBTDL) is added last, and the formulation is again mixed at 3,000 rpm for 1 minute using the Flacktek speed mixer. The prepolymers are then removed from the glove box and placed in an HTR heated/mixing station at 80° C. for 4 hours. After 4 hours, the samples are placed back into the glove box, and the triethylamine (neutralizer) is added. The samples are again mixed using the Flacktek speed mixer at 3,000 rpm for 1 minute. Then, the samples are removed from the glove box and deionized water is added in a fume hood. The samples are hand shaken vigorously for about 2 minutes and then placed in the Flacktek mixer at 3,000 rpm for 1 minute (on the benchtop)—repeated mixing 3 times or until samples are uniform. Then, in a fume hood, the ethylene diamine (chain extender) (30 wt % ethylene diamine in deionized water) is added. Samples are mixed again using the Flacktek speed mixer at 3,000 rpm for 1 minute or until samples are uniform. Samples are left overnight on the benchtop and coatings are made the following day.

The coatings for the above Comparative Examples and Inventive Example are prepared as follows in order to measure Martens Hardness. Coatings are made using the semi-automated Reactive Coating Station (RCS). The RCS uses a metal doctor blade set to a gap of 1.15 mm=5.9 mil wet thickness to coat the PUD onto an aluminum substrate (Q-Lab Corporation (Q-Panel), Stock #SP-105523—Bare Aluminum 0.025×3.06″×4.725″ square corners, no holes). A total of 4 coatings are made for each of the Comparative and Inventive Examples. The coatings are left to cure for 7 days at room temperature in a 50% relative humidity lab before performing adhesion and hardness testing. A micro indenter is used with a force of 5.000 mN/10 second (creep=10 seconds) using a diamond tip. A total of 5 points are measured for Martens Hardness on each sample.

The polyurethane dispersion containing DMPA/DPGDME (Comparative Example A) was found to precipitate after dispersion and chain extension leading to the formation of solid particles. This required filtration prior to coating of the aluminum substrate. In comparison, the polyurethane dispersion containing DMBA in DPGDME (Inventive Example 1) was stable without any precipitation and therefore could be used for further coating assessment without any filtration.

Regarding Martens Hardness, the coatings made with Inventive Example 1 (DMBA/DPGDME) exhibited an average Martens Hardness of over 22 N/mm², whereas the coatings made with Comparative Example B exhibited an average Martens Hardness of less than 13 N/mm².

Additional samples of Inventive Example 1 and Comparative Examples A and B are prepared as described above in order to measure turbidity and particle size. Turbidity is measured using a Hach Ratio Turbidimeter with a range of 0-200 NTU. Measurements are taken at room temperature using an 8 dram sample cell. The calibration of the instrument is confirmed using Gelex Turbidity Standards. Each sample is allowed to equilibrate for at least 15 seconds for the reading to stabilize. The results are shown in Table 5.

Particle size analysis and distribution measurements are performed using a Beckman Coulter LS 13 310 laser diffraction analyzer equipped with a universal liquid module (ULM). The LS 13 310 combines polarization effects of light scattering with wavelength dependence at high angles to extend the lower size limit to 40 nm, almost reaching the theoretical limit. This is referred to as Polarization Intensity Differential Light Scattering (PIDS) technology. Utilizing PIDS, the particle size distribution range measured by the LS 13 310 with ULM is 0.017 to 2000 μm. Deionized water is utilized as the liquid media in the ULM. A small fraction of each sample is pipetted into a different vial where it is diluted with deionized water to obtain an adequate concentration of the material. These samples are then passed through the beam of a monochromatic light source (laser) with the PIDs turned on and data is collected. The results are shown in Table 5.

Comparative Example B (DMPA as emulsifier and NMP as solvent) exhibited uniform particle size at 0.085 μm, which is beneficial to providing good coating properties. However, as previously noted, NMP is less desirable from an EHS standpoint and is forbidden to use in many geographies. Comparative Example A (DMPA as emulsifier and DPGDME as solvent) exhibited bi-modal particle size distribution at 0.086 μm and 1.985 μm. The large PUD particles may require filtration before application in a coating process, or this PUD formulation could result in poor coating properties. Inventive Example 1 (DMBA as emulsifier and DPGDME as solvent) exhibited a uniform a particle size at 0.104 μm, which is similar to DMPA/NMP method with a particle size at 0.085 μm. The uniform particle offers good PUD coating properties.

The turbidity measurement of Comparative Example A (DMPA/DPGDME) is slightly higher (18ONTU), which might be caused by the larger PUD particles at 1.985 μm. Turbidity measurements of Comparative Example B (DMPA/NMP) and Inventive Example 1 (DMBA/DPGDME) are lower at −130 NTU due to the smaller particle size of the PUD.

TABLE 5

| | | | Mean of |
|---|---|---|---|
| | | Turbidity | particle size |
| | PUD | (NTU) | (μm) |
| Comparative | DMPA/ | 180 | 0.086; 1.985 |
| Example A | DPGDME | | |
| Comparative | DMPA/NMP | 131 | 0.085 |
| Example B | | | |
| Inventive | DMBA/ | 127 | 0.104 |
| Example 1 | DPGDME | | |

1. A process for making a prepolymer comprising an acid group, the process comprising the step of contacting
(i) a di-isocyanate,
(ii) a diol containing an acid group, wherein the diol containing an acid group is 2,2 dimethylolbutanoic acid, and
(iii) a polyol without an acid group,
the contacting conducted under reaction conditions and in a solvent consisting essentially of dipropylene glycol dimethyl ether.

2. A three-step process for making a water-based polyurethane dispersion (PUD), the process comprising the steps of:
(1) forming a prepolymer with an acid group by contacting:
(i) a di-isocyanate,
(ii) a diol containing an acid group, wherein the diol containing an acid group is 2,2 dimethylolbutanoic acid, and
(iii) a polyol without an acid group,
the contacting conducted under reaction conditions and in a solvent consisting essentially of dipropylene glycol dimethyl ether;
(2) neutralizing the acid group of the prepolymer with a base; and
(3) dispersing the neutralized prepolymer in water.

3. The process of claim 1 in which the acid group is a carboxyl group.

4. The process of claim 2, further comprising (4) adding a chain extender to the neutralized prepolymer in water, wherein the chain extender is a polyol or a diamine.

5. The process of claim 1, wherein the contacting step to form the prepolymer with acid group further comprises a metal salt catalyst.

6. The process of claim 5 in which the metal salt catalyst is an organic tin salt catalyst.

7. A polyurethane dispersion (PUD) comprising (i) a chain-extended prepolymer comprising a neutralized acid group, (ii) dipropylene glycol dimethyl ether, and (iii) water.

8. The PUD of claim 7 in which the prepolymer comprises 5 to 60 percent by mass of the dispersion.
